(19) United States
(12) Patent Application Publication
(10) Pub. No.: US 2011/0235897 A1
(43) Pub. Date: Sep. 29, 2011

(54) DEVICE AND PROCESS FOR THREE-DIMENSIONAL LOCALIZATION AND POSE ESTIMATION USING STEREO IMAGE, AND COMPUTER-READABLE STORAGE MEDIUM STORING THE PROGRAM THEREOF

(75) Inventors: Masaharu Watanabe, Osaka (JP); Fumiaki Tomita, Osaka (JP); Kouta Fujimura, Osaka (JP); Yasuyuki Ikeda, Osaka (JP); Kengo Ichimura, Osaka (JP)

(73) Assignees: NAT'L INSTITUTE OF ADVANCED INDUSTRIAL SCIENCE AND TECHNOLOGY, Tokyo (JP); FACTORY VISION SOLUTIONS CORPORATION, Osaka (JP)

(21) Appl. No.: 13/052,659

(22) Filed: Mar. 21, 2011

(30) Foreign Application Priority Data
Mar. 24, 2010 (JP) 2010-067275
Feb. 8, 2011 (JP) 2011-024715

(51) Int. Cl. G06K 9/00

(52) U.S. Cl. 382/154

(57) ABSTRACT

The device includes:
an input unit (4) for receiving image data obtained by capturing images of an object by imaging units (C1 to C3); and
an arithmetic unit (1) that performs:
1) finding a three-dimensional reconstruction point set that contain three-dimensional position information of segments obtained by dividing a boundary of the object in the image data, and a feature set that contain three-dimensional information regarding vertices of the segments, for each of multiple pairs of two different images;
2) calculating a total three-dimensional reconstruction point set and a total feature set by totaling the three-dimensional reconstruction point sets and the feature sets of the multiple pairs; and
3) matching a model feature set regarding model data of the object with the total feature set, thereby determining, among the total three-dimensional reconstruction point set, points corresponding to model points of the object.

### TECHNICAL FIELD

The present invention relates to a device and a process for carrying out three-dimensional localization and pose estimation of an object using images of the object captured by a plurality of cameras; and a computer-readable storage medium storing the program thereof.

### BACKGROUND ART

The stereo method is a technique for reconstructing a three-dimensional environment using images captured by a plurality of cameras at different viewpoints. In recent years, the image recognition technique has become more frequently used in the factory automation field. Particularly, among them, the stereo method has a function of measuring a three-dimensional shape, size, localization and pose of the target object with high accuracy. This function cannot be achieved by other image processing techniques. With this advantage, the stereo method is widely applicable in the industrial field; for example, for manipulation of robots for bin-picking of randomly placed parts. Moreover, the stereo method can be performed at low cost only by acquiring conventional image information from different viewpoints, without requiring special hardware. For this reason, there is a high expectation for actual utilization of the localization and pose estimation technique according to the stereo method.

On the other hand, the stereo method has a long-held problem called “occlusion”, which occurs due to the positional difference between the cameras. Occlusion is a condition more specifically called “self-occlusion phenomenon”, in which a part of an edge of the target object is overlapped by the object itself; therefore, said part can be captured by one camera, but cannot be captured by another camera. When the three-dimensional reconstruction is performed with an image set having occlusion, a stereo correspondence error occurs in the defective part, thereby failing the recognition of the target object, or measuring incorrect localization and pose due to the resulting false three-dimensional reconstructed structure. This problem has been a drawback of the stereo method.

FIG. 3 shows an example of occlusion. The three images are respectively called, from left to right, the first, second and third camera images. First, in the right lateral face of the target object of each image, no occlusion occurs in the combination of the first camera and the third camera; accordingly, the proper stereo correspondence was obtained.

In contrast, on the same right lateral face, the edge on the far side of the right lateral face can be seen in the second camera, but cannot be seen in the first camera (it is not displayed in the first camera image). More specifically, the combination of the first camera image and the second camera image has occlusion.

When three-dimensional reconstruction is performed with such an image set having occlusion, a stereo correspondence error occurs in the defective part, thereby failing the recognition of the target object, or measuring incorrect localization and pose due to the resulting false three-dimensional reconstructed structure. Therefore, occlusion is a major hurdle of factory utilization of the stereo method.

As one solution of this problem, there is a known method that uses an extra camera to verify three-dimensional reconstructed structures obtained by the conventional binocular camera so as to eliminate correspondence errors. This process eliminates all information other than the information observable by all cameras. For example, in FIG. 3, by referring to the third camera image to verify the three-dimensional reconstructed structures captured by the combination of the first and second cameras, the correspondence error can be found.

Moreover, in the case of FIG. 3, it is also possible to determine stereo correspondence according to luminance matching condition with respect to the region (surface) containing the edge.

### CITATION LIST

### Non-Patent Literature

[Non-patent Literature 1] Fumiaki Tomita, Hironobu Takahashi, “Matching Boundary Representations of Stereo Images”, THE TRANSACTIONS OF THE INSTITUTE OF ELECTRONICS AND COMMUNICATION ENGINEERS OF JAPAN, D, vol. J71-D, No. 6, pp. 1074-1082, June 1988
[Non-patent Literature 2]
Yasushi Sumi, Fumiaki Tomita, “Three-Dimensional Object Recognition Using Stereo Vision”, THE TRANSACTIONS OF THE INSTITUTE OF ELECTRONICS, INFORMATION AND COMMUNICATION ENGINEERS, D-II, vol. J80-D-II, No. 5, pp. 1105-1112, May 1997

### SUMMARY OF INVENTION

### Technical Problem

However, in some cases of the method of eliminating information other than the information observable by all cameras, depending on the geometric positioning of the cameras and the target object upon image-capturing, the verification of the right lateral face of a three-dimensional reconstructed structure created by the first camera image and the third camera image is performed by the second camera image; more specifically, only the camera image for verification may contain occlusion. In this case, even though the result of stereo correspondence is correct, the result would not be approved (more specifically, in some cases, a correct correspondence may be eliminated as a false correspondence). This disadvantage has been considered a problem to be solved. This problem could be solved by adopting a combined result of multiple stereo processes in which the order of the basic image, the reference image, and the verification image are switched. However, it is still a fact that the determination of false correspondence is principally impossible using a trinocular camera.

Further, the process of determining stereo correspondence by referring to luminance matching condition of the region (surface) containing the edge also has a problem such that the luminance difference between the respective surfaces of the object greatly depends on the degree of exposure and other conditions (material, surface treatment condition, etc. of the target object, lighting position, performance of camera etc.). In the actual factory environments, overexposure or the like may unavoidably occur due to various factors. In this case, as shown in FIG. 4, the details of the shape of the object in the obtained image are not shown, thereby failing to detect the edge of the object in the region. When edge detection is performed with respect to the image of FIG. 4, although the outer edge of the target object may be detectable, the boundary edge is not detectable due to the slight difference in reflection luminance on the adjacent surfaces thought to exist inside the object (for example, the upper face and a lateral face, etc.). Therefore, this also results in false stereo correspondence due to occlusion.

Although a great deal of research was conducted to improve the accuracy of three-dimensional reconstruction, elimination of false stereo correspondence data, and detection of occlusion by using at least three cameras, no intensive research was conducted for a method for measuring the localization and pose of an object without influence of a part of three-dimensional reconstructed structure generated by false stereo correspondence.

In order to solve the foregoing problems, an object of the present invention is to provide a device and method capable of measurement of three-dimensional localization and pose of a target object without influence of false stereo correspondence data that may be contained in a portion of image data captured by at least three cameras; and a computer-readable storage medium storing the program thereof.

### Solution to Problem

The object of the present invention is attained by the following means.

Specifically, a three-dimensional localization and pose estimation device according to the present invention comprises:

an input unit for receiving three or more items of image data obtained by capturing images of an object by imaging units at different viewpoints; and

an arithmetic unit,

wherein:

the arithmetic unit performs:

1) finding a three-dimensional reconstruction point set and a feature set for each of multiple pairs of two different images selected from the three or more items of image data,

2) calculating a total three-dimensional reconstruction point set and a total feature set by totaling the three-dimensional reconstruction point sets and the feature sets of the multiple pairs,

3) matching a model feature set regarding model data of the object with the total feature set, thereby determining, among the total three-dimensional reconstruction point set, points corresponding to model points of the object;

the three-dimensional reconstruction point set contains three-dimensional position information of segments obtained by dividing a boundary of the object in the image data; and

the feature set contains three-dimensional information regarding vertices of the segments.

A second three-dimensional localization and pose estimation device according to the present invention is arranged such that, based on the first three-dimensional localization and pose estimation device,

the segments are approximated by straight lines, arcs, or a combination of straight lines and arcs;

the three-dimensional information regarding the vertices comprises three-dimensional position coordinates and two types of three-dimensional tangent vectors of the vertices;

in Step (3), the process of matching a model feature set regarding model data of the object with the total feature set is a process of finding a transformation matrix for three-dimensional coordinate transformation, thereby matching a part of the model feature set with a part of the total feature set; and

in Step (3), the process of determining, among the total three-dimensional reconstruction point set, points that correspond to model points of the object is a process for evaluating a concordance of a result of three-dimensional coordinate transformation of the model points using the transformation matrix with the points of the total three-dimensional reconstruction point set.

A process for measuring three-dimensional localization and pose according to the present invention comprises the steps of:

1) obtaining three or more items of image data by capturing images of an object by imaging units at different viewpoints;

2) finding a three-dimensional reconstruction point set and a feature set for each of multiple pairs of two different images selected from the three or more items of image data;

3) calculating a total three-dimensional reconstruction point set and a total feature set by totaling the three-dimensional reconstruction point sets and the feature sets of the multiple pairs;

4) matching a model feature set regarding model data of the object with the total feature set, thereby determining, among the total three-dimensional reconstruction point set, points corresponding to model points of the object;

wherein:

the three-dimensional reconstruction point set contains three-dimensional position information of segments obtained by dividing a boundary of the object in the image data; and

the feature set contains three-dimensional information regarding vertices of the segments.

A computer-readable storage medium according to the present invention stores a program for causing a computer to execute the functions of:

1) obtaining three or more items of image data by capturing images of an object by imaging units at different viewpoints;

2) finding a three-dimensional reconstruction point set and a feature set for each of multiple pairs of two different images selected from the three or more items of image data;

3) calculating a total three-dimensional reconstruction point set and a total feature set by totaling the three-dimensional reconstruction point sets and the feature sets of the multiple pairs;

4) matching a model feature set regarding model data of the object with the total feature set, thereby determining, among the total three-dimensional reconstruction point set, points corresponding to model points of the object;

wherein:

the three-dimensional reconstruction point set contains three-dimensional position information of segments obtained by dividing a boundary of the object in the image data; and

the feature set contains three-dimensional information regarding vertices of the segments.

### Advantageous Effects of Invention

The present invention enables accurate localization and pose estimation without influence of a three-dimensional reconstructed structure generated by false stereo correspondence that may occur in a portion of image data due to occlusion or the like. In the conventional method that supplementarily uses an additional camera image for verification, there are some cases where a correct combination of stereo correspondence is regarded as false correspondence due to verification camera image information. However, since the present invention handles all of the three-dimensional reconstructed structures captured by different combinations of multiple cameras equally, the reconstruction result will not depend on the combination of the cameras. Therefore, it becomes possible to more accurately perform localization and pose recognition regardless of the geometric positioning of the cameras and the target object.

### BRIEF DESCRIPTION OF DRAWINGS

FIG. 1 A block diagram showing a schematic structure of a three-dimensional localization—and pose-estimating device according to an embodiment of the present invention.

FIG. 2 A flow chart showing processes carried out by a three-dimensional localization—and pose-estimating device according to an embodiment of the present invention.

FIG. 3 Photos showing an example of occlusion among stereo images.

FIG. 4 Photos showing stereo images, which are captured in the same geometric condition as those of FIG. 3, but are under overexposure.

FIG. 5 A trihedral view showing a model used in First Example.

FIG. 6 A drawing in which a result of localization and pose estimation according to the present invention with respect to the image set of FIG. 4 is projected on the first camera image.

FIG. 7 A drawing showing distribution of model points and data points according to the result of FIG. 6.

FIG. 8 A drawing showing distribution of points obtained by the first and second camera images of FIG. 4, among the distribution diagram of FIG. 7.

FIG. 9 A drawing showing distribution of points obtained by the second and third camera images of FIG. 4, among the distribution diagram of FIG. 7.

FIG. 10 A drawing showing distribution of points obtained by the first and third camera images of FIG. 4, among the distribution diagram of FIG. 7.

FIG. 11 A drawing in which a result of localization and pose estimation of a candidate resulting from initial matching using vertices generated from the first and second camera image pair of FIG. 4 is projected on the first camera image.

FIG. 12 A drawing showing distribution of points obtained from the first and second camera images, according to the result of FIG. 11.

FIG. 13 A drawing showing distribution of points obtained from the second and third camera images, according to the result of FIG. 11.

FIG. 14 A drawing showing distribution of points obtained from the first and third camera images, according to the result of FIG. 11.

FIG. 15 A drawing showing distribution of model points and data points, according to the result of FIG. 11.

FIG. 16 A perspective view showing a shape of a model used in Second Example.

FIG. 17 Trinocular stereo paired images obtained by actually capturing images of a target object.

FIG. 18 Images showing results of perspective projection of a model on the first and second images of FIG. 17, according to the measuring result obtained by a conventional process.

FIG. 19(a) through (f) Diagrams showing multiple results of projection of a 3D reconstruction data point group on a model coordinate system according to a localization—and pose-estimating result obtained by a conventional process.

FIG. 20 Diagrams showing a result of perspective projection of a model on each of the three images of FIG. 17, according to a measuring result obtained by a process of the present invention.

FIG. 21(a) through (f) Diagrams showing multiple results of transformation of a 3D reconstruction data point group on a model coordinate system, according to a localization—and pose-estimating result obtained by a process of the present invention.

### DESCRIPTION OF EMBODIMENTS

An embodiment of the present invention is described below in reference to the attached drawings.

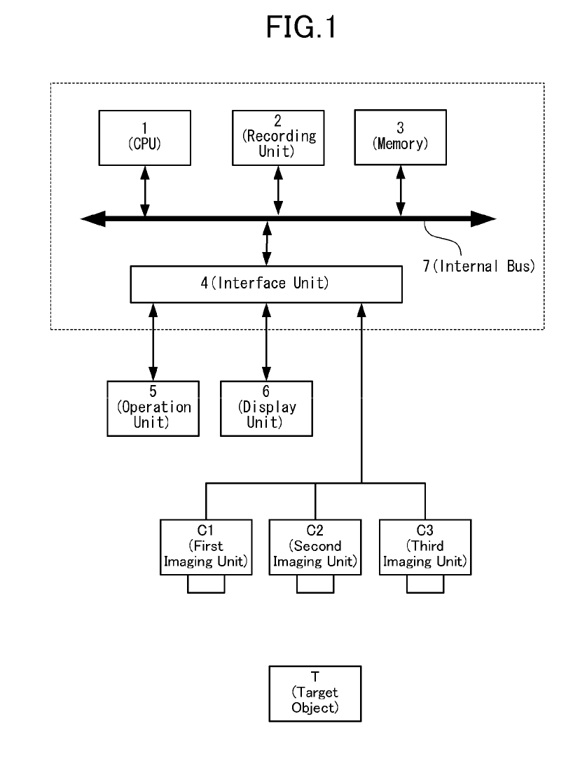

FIG. 1 is a block diagram showing a schematic structure of a three-dimensional localization and pose estimation device according to an embodiment of the present invention. The present device is composed of an arithmetic processing unit (hereinafter referred to as a CPU) 1, a recording unit 2 for recording data, a storage unit (hereinafter referred to as a memory) 3, an interface unit 4, an operation unit 5, a display unit 6, an internal bus 7 for exchanging data (including control information) between the units, and first to third imaging units C1 to C3. In the following, the CPU 1, the recording unit 2, the memory 3, the interface unit 4, and the internal bus 7 are also referred to as a main body unit.

The CPU 1 reads out a predetermined program from the recording unit 2, and develops the data in the memory 3 to execute predetermined data processing using a predetermined work area in the memory 3. The CPU 1 records, as required, results of ongoing processing and final results of completed processing in the recording unit 2. The CPU 1 accepts instructions and data input from the operation unit 5 via the interface unit 4, and executes the required task. Further, as required, the CPU 1 displays predetermined information in the display unit 6 via the interface unit 4. For example, the CPU 1 displays a graphical user interface image showing acceptance of input via the operation unit 5 in the display unit 6. The CPU 1 acquires information regarding conditions of the user's operation with respect to the operation unit 5, and executes the required task. For example, the CPU 1 records the input data in the recording unit 2, and executes the required task. The present device may be constituted of a computer. In this case, computer keyboards, mice, etc. may be used as the operation unit 5. CRT displays, liquid crystal displays, etc. may be used as the display unit 6.

The first to third imaging units C1 to C3 are disposed in predetermined positions at a predetermined interval. The first to third imaging units C1 to C3 capture images of a target object T, and send resulting image data to the main body unit. The main body unit records the image data sent from the imaging units via the interface unit 4 in a manner to distinguish the respective data items from each other; for example, by giving them different file names according to the imaging unit. When the output signals from the first to third imaging unit C1 to C3 are analog signals, the main body unit comprises an AD (analog-digital) conversion unit (not shown) to sample the input analog signals supplied at predetermined time intervals into digital data. When the output signals from the first to third imaging unit C1 to C3 are digital data, the AD conversion unit is not necessary. The first to third imaging units C1 to C3 are at least capable of capturing still pictures, and optionally capable of capturing moving pictures. Examples of the first to third imaging units include digital cameras, and digital or analog video cameras.

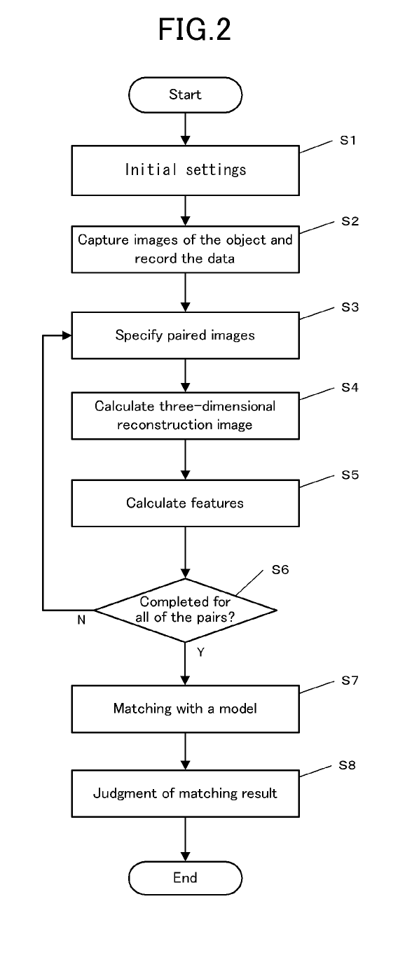

An operation sequence of the present device is described below in reference to the flow chart of FIG. 2. In the following description, all operations are carried out by the CPU 1; more specifically, the CPU 1 causes the respective units to execute the operations, unless otherwise specified. Further, the first to third imaging units C1 to C3 are disposed in predetermined positions at a predetermined interval to be capable of capturing images of a target object T. The information regarding the positions and image-capturing directions of the imaging units C1 to C3 are stored in the recording unit 2, as well as the three-dimensional shape data of the target object T. The internal and external parameters of the first to third imaging units C1 to C3 are previously found by a calibration test, and stored in the recording unit 2.

In Step S1, the initial settings are made. The initial settings are required to enable the processes in Step S2 and later steps. In the initial settings, for example, the control protocol and data transmission path for the first to third imaging units C1 to C3 are established to enable control of the first to third imaging units C1 to C3.

In Step S2, images of the target object T are captured by the first to third imaging units C1 to C3. The captured images are sent to the main body unit, and are recorded in the recording unit 2 with predetermined file names. In this manner, three items of two-dimensional image data captured at different localizations and directions are stored in the recording unit 2. In this embodiment, the three items of two dimensional image data obtained by the first to third imaging units C1 to C3 are represented by Im1 to Im3.

In Step S3, two items out of the three image data items Im1 to Im3 stored in the recording unit 2 in Step S2 are specified as paired images. More specifically, either of a pair of Im1 and Im2, a pair of Im2 and Im3, or a pair of Im3 and Im1 is specified.

In Step S4, using the two items of two-dimensional image data specified as paired images in Step S3, a three-dimensional reconstructed structure (a set of three-dimensional reconstruction points) is calculated by stereo correspondence. Here, the correspondence is not found by points (pixels), but by more comprehensive units, i.e., “segments”. This can reduce the search space to a considerable degree, compared with the point-based image reconstruction. For the detailed processing method, the conventional method disclosed in the above Non-patent Literature 1 can be referenced. The following explains only the operation directly related to the present invention.

The reconstruction is performed by carrying out a series of three-dimensional reconstruction processes by sequentially subjecting each image of the paired images to (a) edge detection, (b) segment generation, and (c) three-dimensional reconstruction by evaluation of segment connectivity and correspondence between the images. Hereinafter, a set of three-dimensional reconstruction points regarding the paired images obtained in Step S4 is represented by Fi. Because Step S4 is repeated for all pairs as described later, “i” discriminates the pair. In this embodiment, “i” is either 1, 2 or 3, since two items are selected out of three images.

### (a) Edge Detection

Any known image-processing method can be used for edge detection of each image. For example, the strength and direction of the edge of each point of the image are found by a primary differential operator; and a closed edge (also referred to as a boundary) surrounding a region is obtained by non-maximum suppression, thresholding, and edge extension.

### (b) Segment Generation

Segments are generated using the two edge images obtained above. A “segment” is obtained by dividing an edge into a plurality of line (straight line) components. At first, the boundary is tentatively divided with a predetermined condition, and the segments are approximated by straight lines according to the method of least squares. Here, if there are any segments having a significant error, the segment is divided at a point most distant from the straight line connecting the two ends of the segment (a point having the largest perpendicular line with respect to the straight line in the segment). This process is repeated to determine the points to divide the boundary (divisional point), thereby generating segments for each of the two images, and further generating straight lines for approximating the segments.

The processing result is recorded in the recording unit as a boundary representation (structural data). More specifically, each image is represented by a set of multiple regions. Each region R is represented by a list of an external boundary B of the region and a boundary H with respect to the inner hole of the region. The boundaries B and H are represented by a list of segments S. Each region is defined by values representing a circumscribed rectangle that surrounds the region, and a luminance. Each segment is oriented so that the region containing the segment is seen on the right side. Each segment is defined by values representing coordinates of the start point and the end point, and an equation of the straight line that approximates the segment. Such data construction is performed for the two images. The following correspondence process is performed on the data structure thus constructed.

### (c) Three-Dimensional Reconstruction

Next, corresponding segments are found from the two images. Although the segments represent images of the same object, it is not easy to determine correspondences of the segments because of the variable lighting conditions, occlusion, noise, etc. Therefore, first, correspondences are roughly found on a region basis. As a condition to determine a correspondence of a pair of the regions, it is necessary to satisfy that the difference between the luminances of the regions is equal to or less than a certain value (for example, a level 25 for 256-scale luminance), and that the regions contain points satisfying the epipolar condition. However, since this is not a sufficient condition, multiple corresponding regions may be found for a single region. More specifically, this process finds all potential pairs having the corresponding boundaries, so as to reduce the search space for finding correspondences on a segment basis. This is a kind of coarse-to-fine analysis.

Among the segments roughly assumed to compose the same boundary, potential corresponding segment pairs are found and summarized in a list. Here, as a condition to determine a correspondence of a pair of the segments, it is necessary to satisfy that the segments have corresponding portions satisfying the epipolar condition, that upward or downward orientations of the segments (each segment is oriented so that the region containing it is seen on the right side) are matched, and that the difference of angles of the orientations falls within a certain value (e.g., 45°).

Thereafter, for each of the potential segment pairs, the degree of similarity, which is represented by values C and D, is found. “C”, as a positive factor, denotes a length of the shorter segment among the corresponding two segments. “D”, as a negative factor, denotes a difference in parallax from the start point to the end point between the corresponding segments. The potential segment pairs found at this stage contain multiple correspondences in which a single segment corresponds to multiple segments on the same y axis (vertical direction). As explained below, false correspondences are eliminated according to a similarity degree and a connecting condition of the segments.

Next, for each of the two images, a list of connected segments is created. To satisfy the condition to determine the connection of two segments, it is necessary for the difference between the luminances of the regions containing the segments to be equal to or less than a certain value (for example, a level 25); and for the distance between the end point of one segment to the start point of the other segment to be less than a certain value (for example, 3 pixels). Basically, if one of the segments of a pair is a continuous segment, the other segment must be a continuous segment. Accordingly, using the connection list and correspondence list, a path showing a string of the corresponding continuous segments connected to and from the segment is found, in the following manner.
When the terminal points of the two corresponding paths are completely matched, and if there are any potential corresponding segment pairs among the segments continuous from those end points, add them to the path.
When one of the terminal points corresponds to the middle point of the other, and if there are any potential segments assumed to correspond to the segment continuous from a single segment, add them to the path.

Further, it may even be possible to determine the connection for the pairs not in direct connection. For example, when a single segment corresponds to two segments, a line component having the largest distance between the both ends of the two segments is temporarily used as a substitute for the two segments. Still further, in some cases, the two continuous segments connected via a point A correspond to two discontinuous segments. In this case, the two discontinuous segments are extended. Then, if the distance between the two points intersecting with the horizontal line that crosses the point A is small, the extended two-line components (one of the ends is the intersecting point) are temporarily determined as two corresponding segments. However, to avoid generating an unnecessarily large amount of temporarily assumed segments, the similarity degree of the temporarily assumed segments and true segments must satisfy C>|D|. In this manner, the operation is repeated until segments to be added to the path are no longer found. By performing the above operation, new temporarily assumed segments are added.

Next, assuming that the paths are projected backwards on a three-dimensional space, the segments composing the same plane are grouped. This serves not only as the plane restraint condition for finding correct segment pairs, but also as a procedure to obtain an output of the boundary on a three-dimensional plane. To confirm that the segments compose the same plane, the following plane restraint theorem is referenced.

Plane restraint theorem: For the standard camera model, with respect to an arbitrary shape on a plane, a projection image on one camera and a projection image on another camera are affine-transformable.

The theorem denotes that a set of segments that exist on the same plane is affine-transformable between stereo images even for segments on an image obtained by perspective projection, thereby enabling validation of flatness of segments on an image without directly projecting segments backwards. The grouping of the segments using the plane restraint theorem is performed as follows.

First, an arbitrary pair of two corresponding continuing segments is selected from the paths of corresponding pairs, so as to form a minimum pair group.

Then, a segment continuous to each segment of the two images is found. Assuming that all terminal points of the three segments thus found exist on the same plane, an affine transformation matrix between two pairs of continuing segments (each pair has three segments) is found according to a method of least squares. To confirm that the three segments exist on a plane, it is verified that the point obtained by affine transformation of either the right or left terminal point is identical with the other terminal point. In the present specification, concordance of two points indicates a state in which the distance between the two points is equal to or less than a predetermined value. Therefore, if the distance is equal to or less than a predetermined value (e.g., 3 pixels), it is determined that the three segments exist on the same plane.

When the above method found that the three segments exist on the same plane, a segment continuous to each of the right and left segments is found again. In this manner, an affine transformation matrix is found for the four corresponding segments, and validation is performed to determine whether the corresponding terminal points satisfy the obtained transformation matrix. Further, if the plane restraint condition is satisfied, the validation is repeated by sequentially validating continuous segments.

As a result of the above process, pairs of segment groups that constitute the plane are found. However, in some cases, multiple pair groups may be obtained with respect to a single segment pair (multiple continuing segments that constitute the plane). Therefore, the degree of shape similarity is calculated for each pair group so that each segment pair is allotted a single pair group with the maximum similarity degree. The similarity degree G of a pair group is a total of the similarity degrees C. and D of the segments contained in the pair group. In the addition, the minus factor D is given a minus sign, i.e., −D is added. Multiple correspondences indicate that there are one or more false-matching pairs. In a false-matching pair, the segment pair has a small correspondence (C is small), a large difference in parallax (|D| is large), and a small number of continuous segments. Hence, the value of similarity degree G of the pair group containing the pair becomes small. Therefore, the pair group having the maximum similarity degree G is sequentially selected, and other corresponding pair groups are eliminated. In this manner, it is possible to specify the corresponding segment pairs among two images.

With the above process, the coordinates of the segments on a three-dimensional space can be found from the differences in parallax of the corresponding segment pairs among two images. Since the differences in parallax can be calculated using functions of segments, the obtained results are based on sub-pixels. Further, the differences in parallax on the segments do not fluctuate. For example, assuming that the equations of the two corresponding segments j among two images are x=fⱼ(y) and x=gⱼ(y), the difference in parallax d between the two segments can be found by d=fⱼ(y)−gⱼ(y). In practice, the three-dimensional segments are expressed by an equation of a straight line.

Using the information and difference in parallax d of the obtained corresponding segments, and taking the positions of two cameras (imaging units) into account, a three-dimensional reconstruction point set Fi is found. A detailed explanation of the calculation method for finding three-dimensional coordinates using the two corresponding points on two images and their difference in parallax is omitted here because there are some known methods adoptable both in the case of disposing optical axes of two cameras in parallel, and in the case of disposing them via an angle of convergence.

The result obtained above is recorded in the recording unit 2 in the form of a predetermined data structure. The data structure is composed of a set of groups G* expressing three-dimensional planes. Each group G* contains information of a list of three-dimensional segments S* constituting the boundary. Each group G* has a normal direction of the plane, and each segment has three-dimensional coordinates of the start and end points, and an equation of a straight line.

In Step S5, calculation of feature is performed with respect to the image data specified as paired images in Step S3. Here, a set of “vertices”, which is a feature required for model matching, is found. A “vertex” refers to an intersection of so-called virtual straight lines, which are composed of two vectors defined by straight lines allotted to spatially-adjacent three-dimensional segments. More specifically, with respect to the three-dimensional reconstruction point set Fi, the intersection of two adjacent tangent lines is found using tangent lines at terminal points of the straight lines allotted to two adjacent segments (in this example using straight lines to approximate the segments, it refers to the straight lines). The obtained intersections are defined as vertices. A set of the vertices is expressed as Vi. Further, an angle between the two tangent vectors (hereinafter referred to as an included angle) is found.

More specifically, the feature refers to a three-dimensional position coordinate of the vertex, an included angle at the vertex, and two tangent vector components. To find the features, the method disclosed in the Non-patent Literature 2 shown above may be used.

In Step S6, a judgment is carried out as to whether the process is completed for all of the three pairs of image data, each of which has a different combination among the two-dimensional image data Im1 to Im3. If there is any unprocessed pair or pairs, the sequence goes back to Step S3 to repeat a sequence from Steps S3 to S5. If the process is completed for all pairs, an entire three-dimensional reconstruction point set Fa (Fa=F1+F2+F3), which is a total of all three-dimensional reconstruction point sets Fi, and an entire vertex set Va (Va=V1+V2+V3), which is a total of all vertex sets Vi, are found. Then, the sequence goes back to Step S7. As required, Fi, Vi (i=1, 2, 3), Fa, and Va are stored in the recording unit 2.

Step S7 performs matching with model data. Here, it is assumed that, with respect to the target object T, the model point set Ft, and the model vertex set Vt corresponding to the entire three-dimensional reconstruction point set Fa and the entire vertex set Va are generated from its three-dimensional shape data; and the generated data is stored in the recording unit 2.

The target object T used in the present invention is an industrial product whose three-dimensional shape is determined in the designing process before the actual manufacture; therefore, it is usually possible to obtain the original three-dimensional shape data (such as CAD data), which may be used to generate the model point set Ft and the model vertex set Vt. If it is not possible to obtain the original data, the above process may be performed using stereo images of the target object T captured at a desirable imaging condition (desirable lighting, imaging position, resolution etc.), thereby generating the model point set Ft, and the model vertex set Vt.

With respect to the entire vertex sets Va and model vertex sets Vt generated from the image data of the target object T, 4×4 (4 columns and 4 rows) coordinate transformation matrices Tj are found for all combinations (denoted by candidate number j) of vertices having similar included angle values, to create a solution candidate group Ca (Ca=ΣCj). This process is called “initial matching”. Then, using each transformation matrix Tj as an initial value, “fine adjustment” is performed according to the Iterative Closest Point (ICP) algorithm using the model point group and the entire three-dimensional reconstruction point set Fa, thereby updating each coordinate transformation matrix Tj. The final coordinate transformation matrix Tj, and the matching level Mj between the model points and the data points are stored in the recording unit 2 as information of each candidate.

For the detailed method, the method disclosed in the above Non-patent Literature 2 can be referenced. The following explains only the operation directly related to the present invention.

The transformation from a three-dimensional coordinate vector a=[x y z]t to a three-dimensional coordinate vector a′=[x′ y′ z′]t (t denotes transposition) is expressed as a′=Ra+P using a 3×3 three-dimensional coordinate rotation matrix R and a 3×1 translation vector P. Therefore, the relative localization/pose of the target object T may be defined by a 4×4 coordinate transformation matrix T for moving a model to match it with a corresponding three-dimensional structure of the captured image data.

$$T = [ \begin{matrix} & R & & P \\ 0 & 0 & 0 & 1\end{matrix} ]$$

First, the initial matching is performed. The initial matching is a process for comparing a model vertex set Vt with the entire vertex set Va in the captured image data, thereby finding a transformation matrix T. However, since it is not possible to previously obtain information of correct vertex correspondence between the model vertex set and the measured set, all likely combinations are presumably determined as candidates.

First, the model vertex VM is assumed to move to match the measurement data vertex VD. According to the relationship between the three-dimensional position coordinates of the vertex VM and VD, the translation vector P of the matrix T is determined. A rotation matrix R is determined according to the directions of two three-dimensional vectors constituting the vertex. If the pair has a large difference in angle θ formed of two vectors constituting the vertex, it is likely that the correspondence is incorrect; therefore, the pair is excluded from the candidates. More specifically, with respect to VM(i) (i=1, . . . , m) and VD(j)(j=1, . . . , n), the matrices Tij (corresponding to the aforementioned coordinate transformation matrix Tj) are found for all combinations A(i,j) satisfying |θM(i)−θD(j)|<θth, which are regarded as correspondence candidates. Here, m and n respectively denote the numbers of vertices existing in the model vertex set VM and the measurement data vertex set VD. The threshold θth may be empirically determined, for example.

Next, fine adjustment is performed. The fine adjustment is a process for finding correspondence between the model points and the data points of the entire three-dimensional reconstruction point set Fa, thereby simultaneously determining the adequacy of A(i, j) and reducing errors contained in matrix Tij(0). The process performs a sequence that repeats transfer of the model points using the coordinate transformation matrix Tij(0) found by the initial matching, a search for image data points (points in the entire three-dimensional reconstruction point set Fa) corresponding to the model points, and an update of coordinate transformation matrix by way of least squares. The details are according to known methods (for example, see the section “3.2 fine adjustment” in the above Non-patent Literature 2).

Since the initial matching uses a local geometric feature, the corresponding point search may not have sufficiently effective recognition accuracy, except for the model points in the vicinity of the vertices used for calculation of Tij. Therefore, the fine adjustment process is preferably performed in the following two stages.

Initial fine adjustment: correspondence errors are roughly adjusted using only model points on the segments constituting the vertices used for initial matching.

Main fine adjustment: the accuracy is increased by using all model points.

Using the final coordinate transformation matrix Tj(Tij) thus obtained, the points on the model are transformed, and the number Mj of points (matched points) in which the distance after the transformation from the model point to the image data point is equal to or less than a predetermined value is found for each candidate. The obtained coordinate transformation matrix Tj and the number of matched points Mj are stored in the recording unit 2.

Step S8 carries out a judgment regarding the result of initial matching. The matched point number Mj is found for all candidates, and the candidates are ranked by Mj in descending order. The coordinate transformation matrix Tj of the top candidate (with the greatest Mj) is defined as a solution showing the localization and pose of the target. More specifically, a coordinate transformation matrix Tj for transforming a segment is determined for each segment of the model.

As described, even in a condition where the stereo correspondence partly generates a false result due to occlusion or the like, the above method enables accurate localization and pose estimation without influence of a three-dimensional reconstructed structure generated by such false stereo correspondence.

In the method in which the additional camera image is used as an auxiliary image used for verification, the reconstruction result varies depending on which camera is used for verification. Therefore, in some cases, a combination having correct stereo correspondence is regarded as an unmatched combination due to the information of a verification camera image. However, according to the present invention, all pairs of the three-dimensional reconstructed structures captured by a different camera pair out of three cameras are equally treated. Therefore, it is possible to prevent the false reconstruction results due to the varying combinations of camera, i.e., varying geometric positions between the cameras and the target object, thereby enabling more accurate localization and pose estimation.

As described above, the present invention adopts a method of assuming a candidate group of local optimum solutions (and in the vicinity thereof) by performing matching of features. More specifically, according to a comparison between respective included angle values, which are the features, of the model and the captured image data, it is likely that a combination having similar values is near the local optimum solution of the multimodal function. Therefore, the present invention finds a candidate group of the initial estimate value (transformation matrix) in the vicinity of the local optimum solution, finds a local optimum solution by the ICP for each candidate (Step S7), and determines a solution having the greatest matched point number among the solution group, thereby finding a global optimum solution (Step S8).

The above embodiment is not to limit the present invention. More specifically, the present invention is not limited to the disclosures of the embodiment above, but may be altered in many ways.

For example, in FIG. 1, three images are captured by three imaging units; however, the sequence of the flow chart in FIG. 2 may be performed using four or more images captured by four or more imaging units. In this case, it is possible to obtain three-dimensional reconstruction results with fewer blind spots, thereby increasing the matched point number of the likely candidates, and thereby further increasing the accuracy in localization and pose estimation. The total number of paired images is expressed as nC2, as two out of n(n≧3) images are selected.

Further, in the above embodiment, the segments are approximated by straight lines; however, the segments may be approximated by straight lines or arcs. In this case, the arcs (for example, the radius of the arc, the directional vector or the normal vector from the center of the arc to the two terminal points, etc.) as well as the vertices can be used as features. Further, the segments may be approximated by a combination of straight lines and arcs (including a combination of multiple arcs). In this case, only the arcs in the two terminal points of the segment may be used as a characteristic of the segment, in addition to the vertices.

When the segments are approximated by arcs (including the case where the segments are approximated by a combination of straight lines and arcs), the calculation of the vertices in Step S5 is performed using the tangent lines at the ends of the arcs. The tangent lines of the arcs can be found by a directional vector from the center of the arc toward the two terminal points. Further, in Step S7, in addition to the process regarding the vertices, a process for finding correspondence candidates for the combination of arcs of a model and obtained image data are also performed. A translation vector P can be determined by three-dimensional coordinates of the two terminal points of the arc, and a rotation matrix R can be determined by a directional vector and a normal vector from the center of the arc toward the two terminal points. It is preferable to exclude a combination of arcs having a great difference in their radii from the candidates. The total of the correspondence candidates obtained by using the vertices and the arcs, i.e., A(i,j) and Tij(0), is regarded as the final result of initial matching.

Further, the above embodiment is carried out by a software program using a computer as the main unit; however, the present invention is not limited to this. For example, a single hardware device or multiple hardware devices (for example, dedicated semiconductor chip (ASIC) and its peripheral circuit) may be used to execute a part or the entirety of the functions divided into multiple functions. For example, when multiple hardware devices are used, the devices may comprise a three-dimensional reconstruction calculation unit for obtaining the three-dimensional reconstructed structures from paired image data by way of stereo correspondence and for finding features required for model matching; a localization—and pose-matching adjustment unit for estimating localization and pose according to similarity of features of the captured image data and a model; and a matching result judgment unit for ranking the candidates in order of matched point number.

### EXAMPLES

Examples of the present invention are described below to further clarify the effectiveness of the present invention.

### First Example

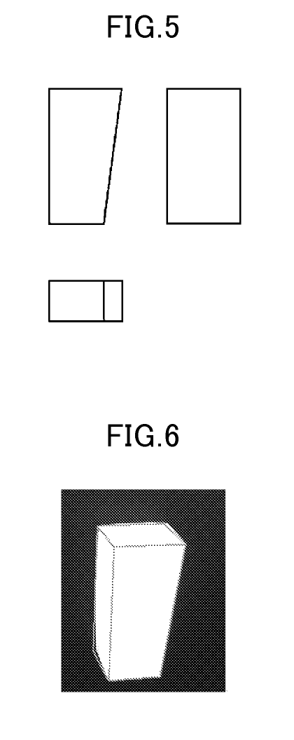

In First Example, to more easily understand the condition of false stereo correspondence, the measurement was performed using a model having a simple shape. An image of the object shown in FIG. 5 was captured using three cameras as the first to third imaging units, and the obtained image data was processed according to the flow chart shown in FIG. 2.

The three cameras were arranged such that the second camera was disposed on the right of the first camera with a base length of 25 cm, and the third camera was disposed upward from the center of the first and second cameras at a 6 cm distance.

As an appropriate target object shown in FIG. 5 to more clearly show the condition of false stereo correspondence, an object having a simple shape, namely, a 40 mm (width)×40 mm (depth)×78 mm (height) rectangular solid with one inclined side was used. The trapezoid shown in the front view has an upper width of 40 mm and a lower width of 30 mm. The rectangular solid was not a complete rectangle, but had an inclined side to prevent redundant multiple model matching candidates due to the structural similarity. Therefore, it should be noted that the use of the model of FIG. 5 does not impair the generality of the present invention.

### Measurement Result of the Process of the Present Invention

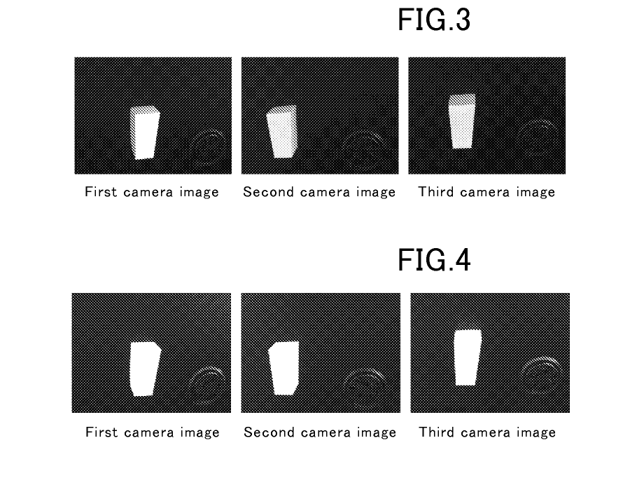

Images of the target object shown in FIG. 5 were captured by the first to third cameras, thereby obtaining three items of image data as shown in FIG. 4. With the obtained image data, Steps S3 to S8 in FIG. 2 were performed. In FIG. 6, an edge of the target object resulting from those steps is superimposed with a part of the first camera image of FIG. 3. As shown in FIG. 6, the localization—and pose-matching of the object was performed almost exactly with respect to the model of FIG. 5.

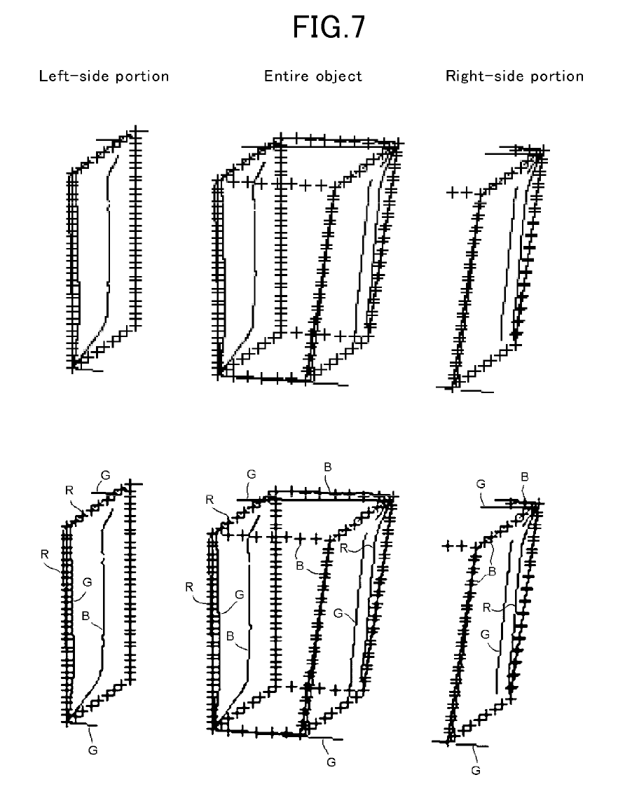

FIG. 7 shows this result as a distribution of image data points (three-dimensional reconstruction points of the target object) and model points. The upper images of FIG. 7 are an assembly of the results of all image pairs of FIG. 4. The model points are shown by cross points. For ease of understanding of the three-dimensional structure, FIG. 7 shows, in addition to the central entire view, the separated right and left sides of the target object. To more clearly show the condition of false stereo correspondence, all of the parts are viewed from a side closer to the second camera.

The lower images of FIG. 7 are obtained by adding reference codes G representing data points generated from the first and second cameras, reference codes R representing data points generated from the second and third cameras, and reference codes B representing data points generated from the first and third cameras.

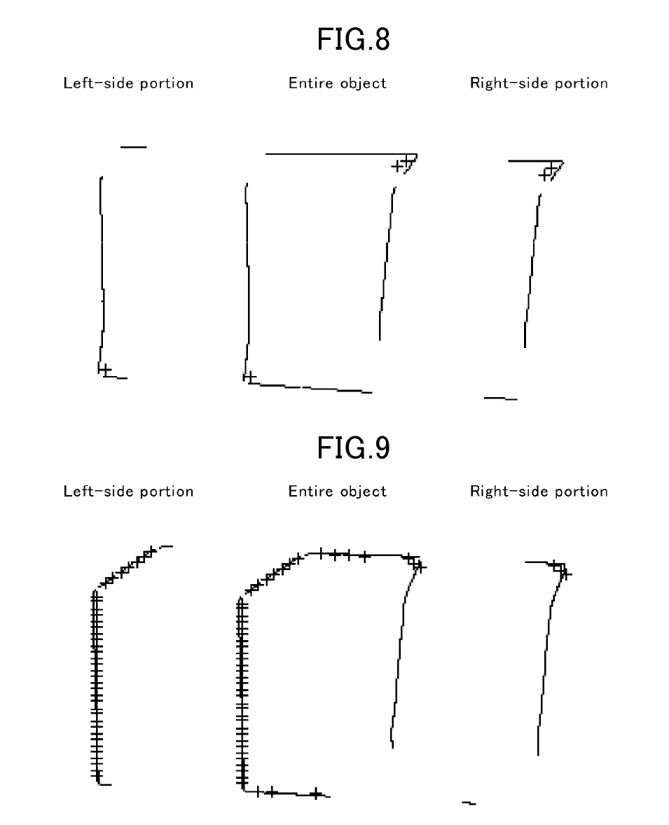

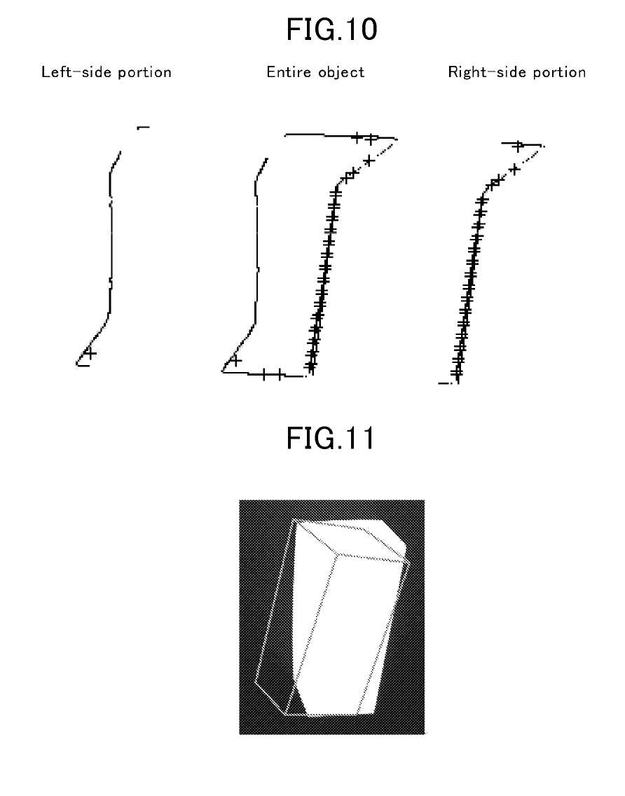

FIG. 8 to FIG. 10 are drawings showing stereo reconstructed structures for constructing the images of FIG. 7. The cross points show the model points matched with the data points. FIG. 8 shows stereo reconstructed structures (the portions shown by the reference codes G in FIG. 7) obtained from the first and second camera images. FIG. 9 shows stereo reconstructed structures (the portions shown by the reference codes R in FIG. 7) obtained from the second and third camera images. In FIG. 9, the portion constituted of the cross points shows accurate reconstruction of the left lateral portion of the object. FIG. 10 shows stereo reconstructed structures (the portions shown by the reference codes B in FIG. 7) obtained from the first and third camera images. In FIG. 10, the portion constituted of the cross points shows accurate reconstruction of the right lateral portion of the object.

In FIG. 8 to FIG. 10, the matching points are determined according to the data points obtained from different pairs. As shown in the figure, this case has more matched points than the case where the matching is performed using a single pair.

### Measurement Result of Conventional Process

The following describes a problem in a conventional matching process using the same captured images (FIG. 4). As described above, the stereo reconstructed structures generated by the first and second camera images are shown by the reference codes G in the lower images of FIG. 7. However, both the left and right lateral sides deviate from the physically correct positions. Such a false stereo correspondence is also shown in the corresponding images in FIGS. 3 and 4. When the conventional matching process is performed only with these paired images, the measurement result will provide physically incorrect localization and pose. Further, in this experiment, the characteristics of the vertices incorrectly formed by the false correspondence segments did not match the model vertices; consequently, when the process reached the final stage after applying all other matching conditions, no candidates were left. Even if the pair of the first and second camera images was verified by the third camera to eliminate the false correspondence segments, few segments will be left and thereby the localization and pose estimation cannot be performed with high accuracy. This process was demonstrated using such a verification function, with the same result as in the case with no verification that no candidates were obtained at the final stage.

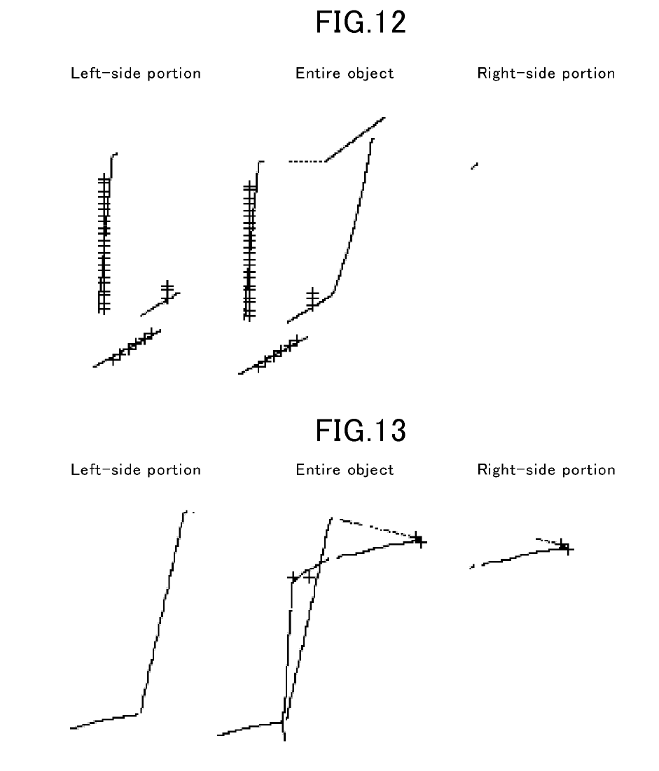

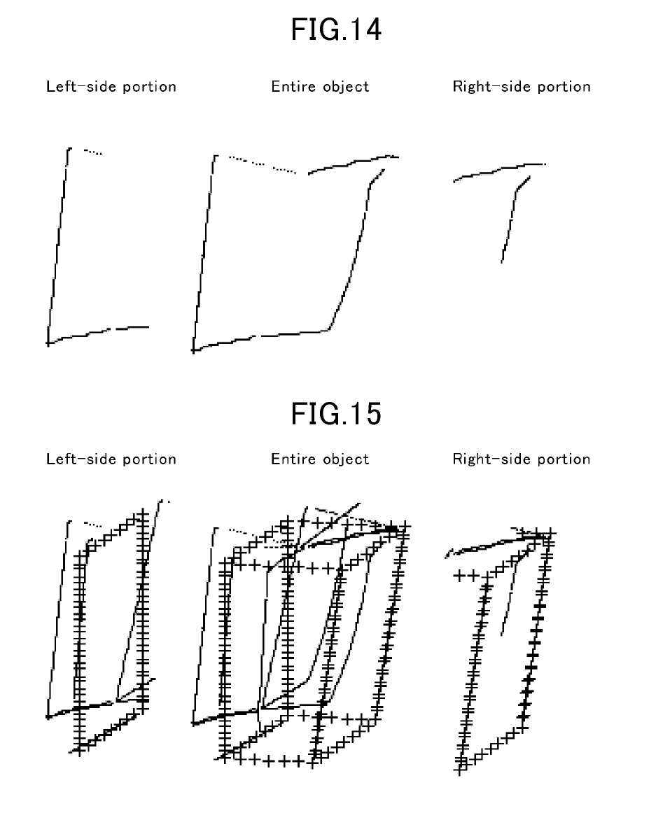

FIGS. 6 to 10 show exemplary results of the correct answer resulting from Step S8, i.e., top candidates selected in Step S8 among the final candidate group determined in Step S7. In contrast, FIGS. 11 to 15 show candidates that were not selected as the top candidates due to false stereo correspondence. FIG. 12 to FIG. 14 correspond to FIG. 8 to FIG. 10, respectively. FIG. 15 shows images obtained by superimposing all of the images in FIG. 12 to FIG. 14 with the model points, corresponding to the upper images in FIG. 7. The images in FIG. 12 to FIG. 14 have a smaller number of matched points (represented as cross points); therefore, a lower rank than the top candidates was given.

As shown above, the present invention is capable of accurate measurement even for an image set whose localization and pose could not be accurately measured by the conventional method due to false stereo correspondence.

### Second Example

In First Example, a model having a simple shape was used to more clearly show the condition of false stereo correspondence. For comparison, another experiment was performed using an object having a more complicated shape. The result of this experiment is explained below as Second Example. In Second Example, the measurement was performed using an L-shaped object as a target object, which is a shape closer to a real industrial component, and a structure simple enough to be drawn on a diagram. The L-shaped object had two L-shaped faces and six rectangular faces.

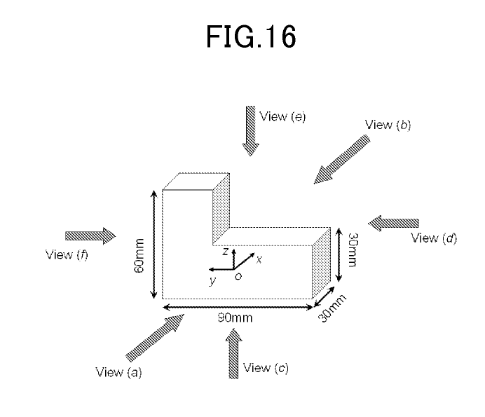

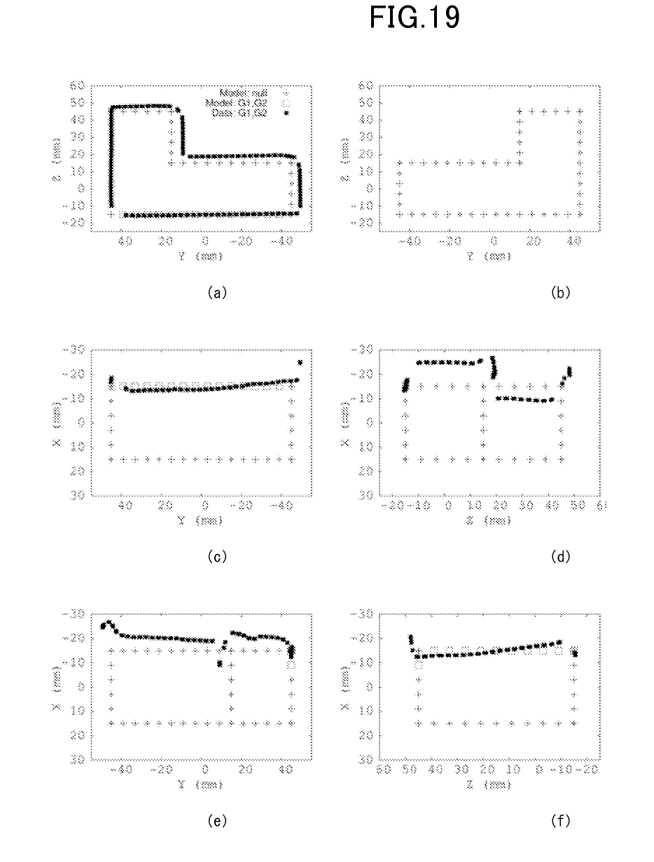

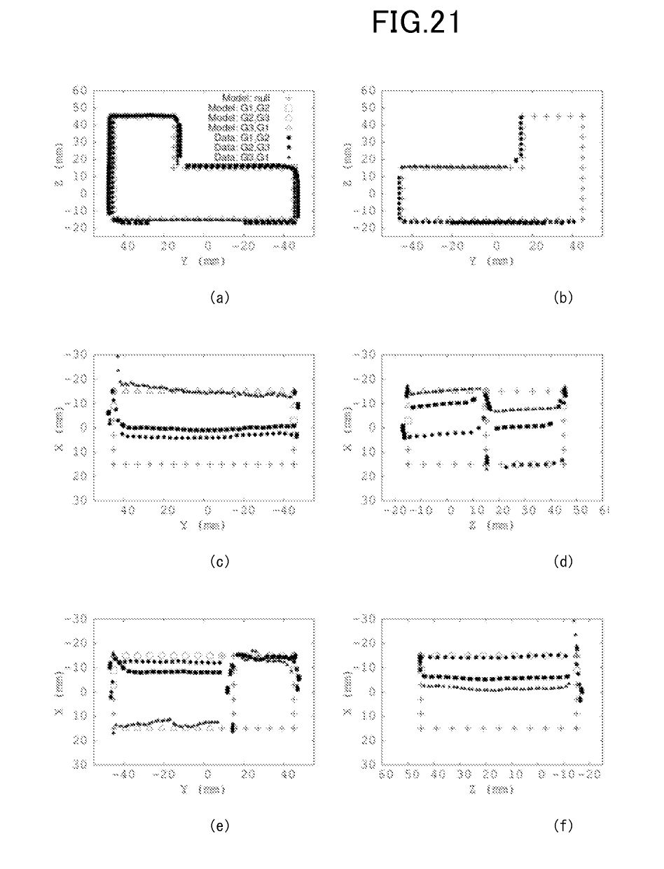

FIG. 16 is a perspective view showing the shape of the model used in Second Example. The arrows labeled as x, y, z in the vicinity of the center of the model show axes of the model-coordinate system, and “o” indicates its origin. The six arrows with labels (a) to (f) indicate respective viewpoints in each figure of FIGS. 19 and 21 showing the results of the matching experiments.

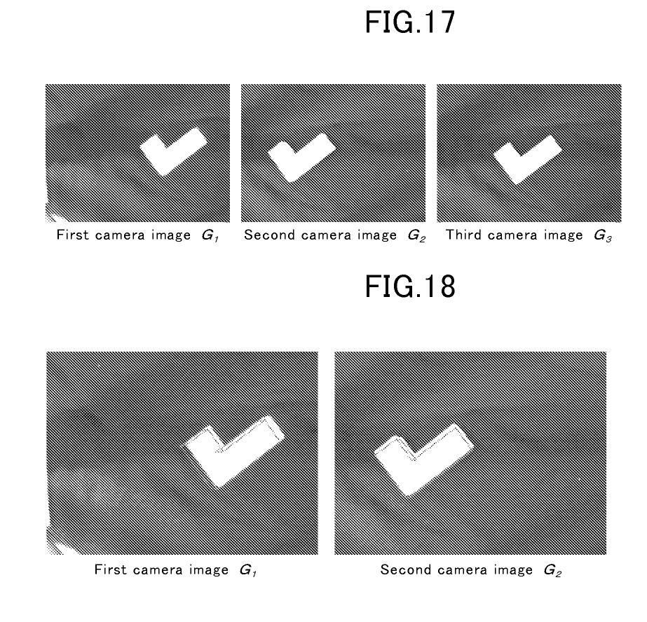

FIG. 17 shows trinocular stereo paired images obtained by actually capturing images of a target object. The cameras have the same arrangement as that of First Example. In the figure, the images are respectively obtained, from left to right, by the first camera C1, the second camera C2, and the third camera C3. Hereinafter, the images are respectively called G₁, G₂, and G₃.

The images in FIG. 17 are captured with long exposure time to an extent disabling detection of geometric edges other than the outline of the target object, in order to simulate the over-/under-exposure condition of the real environment (e.g., in a factory) where the present invention would be performed. Further, in the images shown in FIG. 17, a slight amount of occlusion is generated on the six faces other than the two L-shaped faces among the three images.

### Measurement Results of Conventional Process

Before presenting the results of the process according to the present invention, the following presents results of localization and pose estimation according to a conventional process using binocular stereo paired images (G1, G2). FIG. 18 shows a result of perspective projection of a model on the first and second images of FIG. 17 according to the measurement results of a conventional process. More specifically, the 3D data of the model is transformed in a coordinate form (world coordinate system) of the measurement data, using a coordinate transformation matrix T resulting from the localization and pose estimation. The transformed data is further converted into camera images. The measurement result shown in FIG. 18 is obviously inaccurate, even from observation with the naked eye.

FIG. 19 shows results of transformation of 3D reconstruction data point clouds on a model coordinate system, according to the results of conventional localization and pose estimation. A closed rectangle indicates a data point obtained from stereo paired images (G1, G2), and an open rectangle indicates a model point corresponding to a data point. A cross point indicates a model point that does not correspond to any of the data points. Although the model points are plotted in a world coordinate system in the actual matching process, FIG. 19 shows a model coordinate system in which the measurement data point group is converted using an inverse matrix of the resulting transition matrix T, in order to more clearly show the results.

In the case of 3D data, direct plotting of the model points will not clearly show the three-dimensional relative position of the points. Therefore, in (a)-(f) in FIG. 19, the display region is divided by surfaces. This makes it easier to show the matching results, i.e., the appearances of the measurement data points in the vicinity of each surface of the model. FIG. 19 (a)-(f) respectively correspond to the viewpoints indicated by arrows labeled with (a)-(f) in FIG. 16. More specifically, FIG. 19 (a)-(f) show the model points and measurement data points (transformed into model coordinates) located in the regions x<0, x>0, z<0, y<30, z>0, and y>30, respectively, in the model coordinate system.

The following individually explains FIG. 19 (a) to (f). FIG. 19 (a) shows a visual observation point facing straight at the surface of the L-shaped object. FIG. 19 (b) shows a viewpoint opposite that of FIG. 19 (a), i.e., a viewpoint toward the surface of the L-shaped object (actually, in contact with the floor). FIG. 19 (c) to (f) respectively show viewpoints disposed below, right, above, and left of (a). Therefore, the data of x<0 is shown in (a), and the data of x>0 is shown in (b). In other words, in FIG. 19 (c) to (f), the camera is positioned in an upper portion of each figure, that is, on the negative side of the x-coordinate in the vertical axis.

Observing FIG. 19 (a) and (b) in terms of correspondence between the model and the measurement data, the correspondence is made only in the two sides of the L-shaped surface of (a). In different viewpoints, the model corresponds to the measurement data only in (c) and (f), and matching was not even performed in (d) and (e) because of the long distances between the data points and the model points.

Measurement Results of Process According to the Present Invention

Three items of image data shown in FIG. 17 were obtained by capturing images of the target object shown in FIG. 16 using the first to third cameras. Using the image data of FIG. 17, Steps S3 to S8 in FIG. 2 were performed. The following shows the results.

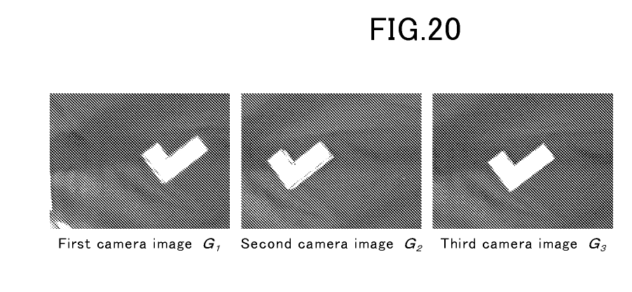

FIG. 20 shows results of perspective projection of a model on each image shown in FIG. 17, according to the measurement results of the process according to the present invention. In comparison with the result shown in FIG. 18, the results show that the localization and pose of the target object were accurately measured. FIG. 21 shows the results of transformation of 3D reconstruction data point group on a model coordinate system according to the localization and pose estimation results of the process according to the present invention. A closed rectangle indicates a data point obtained from stereo paired images (G₁, G₂), a closed circle indicates a data point obtained from stereo paired images (G₂, G₃), and a closed triangle indicates a data point obtained from stereo paired images (G₃, G₁. An open circle indicates a model point corresponding to the data point represented by the closed circle, and an open triangle indicates a model point corresponding to the data point represented by the closed triangle. A cross point indicates a model point that does not correspond to any measurement data. FIG. 21 (a)-(f) respectively correspond to the viewpoints indicated by arrows labeled with (a)-(f) in FIG. 16.

Observing FIG. 21 (a) and (b), it is understood that the measurement data groups that were not associated with the model are more outward than those associated with the model. For example, on the geometric edge that extends in the Z-axis direction in the vicinity of Y=50 in (a), the measurement data of paired images (G₂, G₃) is associated with the model, as shown by the open circles. On the other hand, on the left thereof, the paired images (G₁, G₂) represented by the closed rectangles and the paired images (G₃, G₁) represented by the closed triangles are present. These external measurement data groups represented by the closed rectangles and triangles are virtual images generated by false stereo correspondence.

Observing FIG. 21 (c), (d) and (f), it is understood that, in each figure, measurement data of one of the three paired images constituting an 3D image is associated with one of the model point clouds residing in the position X=±15; that is, the two geometric edges of the model, and the measurement data of the remaining two pairs exist between the two geometric edges. The measurement data groups that are not associated with the model are virtual images generated by false stereo correspondence. It should also be noted that measurement data of a different stereo pair is used for model matching depending on the site.

FIG. 21 (e) is slightly different from the other figures. In the region Y>15, the two geometric edges of the model, more specifically, the model point clouds in the position X=±15, are associated with data of different stereo pairs. On the other hand, the difference in 3D reconstruction position for each pair is small in the region Y<15. This is because of a coincidence in the geometric relation between the third camera C3 and the target object. As assumable from the projection pose of the model in the image G₃ of FIG. 20, the edge near the camera and the edge near the floor of the model are substantially overlapped with the G₃ image in the region Y>15 of FIG. 21 (e). Therefore, the captured geometric edge may be regarded both as the edge near the camera and as the edge near the floor; and the target object was correctly reconstructed, making correspondences with the model point clouds in the position X=±15. Further, the right half of the model contains the same geometric edge (in this example, the edge near the camera) in all images G₁, G₂ and G₃, thereby reducing influence of false stereo correspondence.

In order to show various conditions of stereo correspondence, the present example shows the results regarding the images shown in FIG. 17. However, because no false stereo correspondence occurs on the face shown in FIG. 21 (e) by coincidence, it can be assumed that the measurement was successful. Therefore, the same experiment was performed with respect to different images captured by finely adjusting the pose of the target object so that false stereo correspondence occurs on the face shown in FIG. 21 (e), as in the other faces. In this experiment, the measurement result was provided by matching using only correct stereo correspondence as in FIG. 20. Then, observing the 3D reconstruction result (closed rectangle) according to the stereo pair (G₁, G₂) in FIG. 21 in consideration of this result, it is understood that the major part of the model points is associated with data of pairs other than the pair (G₁, G₂), suggesting that the major part of the image constituted of the stereo pair (G₁, G₂) was a virtual image generated by false stereo correspondence.
1 Arithmetic processing unit (CPU)
2 Recording unit
3 Storage unit (memory)
4 Interface unit
5 Operation unit
6 Display unit
7 Internal bus
C1 First imaging unit
C2 Second imaging unit
C3 Third imaging unit
T Object of image-capturing

1. A three-dimensional localization and pose estimation device, comprising:
an input unit for receiving three or more items of image data obtained by capturing images of an object by imaging units at different viewpoints; and
an arithmetic unit,
wherein:
the arithmetic unit performs:
1) finding a three-dimensional reconstruction point set and a feature set for each of multiple pairs of two different images selected from the three or more items of image data,
2) calculating a total three-dimensional reconstruction point set and a total feature set by totaling the three-dimensional reconstruction point sets and the feature sets of the multiple pairs,
3) matching a model feature set regarding model data of the object with the total feature set, thereby determining, among the total three-dimensional reconstruction point set, points corresponding to model points of the object;
the three-dimensional reconstruction point set contains three-dimensional position information of segments obtained by dividing a boundary of the object in the image data; and
the feature set contains three-dimensional information regarding vertices of the segments.

2. The three-dimensional localization and pose estimation device according to claim 1,
wherein:
the segments are approximated by straight lines, arcs, or a combination of straight lines and arcs;
the three-dimensional information regarding the vertices comprises three-dimensional position coordinates and two types of three-dimensional tangent vectors of the vertices;
in Step (3), the process of matching a model feature set regarding model data of the object with the total feature set is a process of finding a transformation matrix for three-dimensional coordinate transformation, thereby matching a part of the model feature set with a part of the total feature set; and
in Step (3), the process of determining, among the total three-dimensional reconstruction point set, points that correspond to model points of the object is a process for evaluating a concordance of a result of three-dimensional coordinate transformation of the model points using the transformation matrix with the points of the total three-dimensional reconstruction point set.

3. A process for measuring three-dimensional localization and pose, comprising the steps of:
1) obtaining three or more items of image data by capturing images of an object by imaging units at different viewpoints;
2) finding a three-dimensional reconstruction point set and a feature set for each of multiple pairs of two different images selected from the three or more items of image data;
3) calculating a total three-dimensional reconstruction point set and a total feature set by totaling the three-dimensional reconstruction point sets and the feature sets of the multiple pairs;
4) matching a model feature set regarding model data of the object with the total feature set, thereby determining, among the total three-dimensional reconstruction point set, points corresponding to model points of the object;
wherein:
the three-dimensional reconstruction point set contains three-dimensional position information of segments obtained by dividing a boundary of the object in the image data; and
the feature set contains three-dimensional information regarding vertices of the segments.

4. A computer-readable storage medium storing a program for causing a computer to execute the functions of:
1) obtaining three or more items of image data by capturing images of an object by imaging units at different viewpoints;
2) finding a three-dimensional reconstruction point set and a feature set for each of multiple pairs of two different images selected from the three or more items of image data;
3) calculating a total three-dimensional reconstruction point set and a total feature set by totaling the three-dimensional reconstruction point sets and the feature sets of the multiple pairs;
4) matching a model feature set regarding model data of the object with the total feature set, thereby determining, among the total three-dimensional reconstruction point set, points corresponding to model points of the object;
wherein:
the three-dimensional reconstruction point set contains three-dimensional position information of segments obtained by dividing a boundary of the object in the image data; and
the feature set contains three-dimensional information regarding vertices of the segments.
